(19) United States
(12) Patent Application Publication
(10) Pub. No.: US 2010/0181442 A1
(43) Pub. Date: Jul. 22, 2010

(54) DEVICE FOR PLACING RECEPTACLES, SUCH AS PLATES, PROVIDED WITH A PRODUCT

(76) Inventor: Arnoldus Theodorus Bernardus Nales, Terwolde (NL)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/602,862

(22) PCT Filed: Jun. 3, 2008
(86) PCT No.: PCT/NL2008/050346

§ 371 Date: Feb. 18, 2010

(30) Foreign Application Priority Data
Jun. 6, 2007 (NL) 1033941

(51) Int. Cl. F16M 11/04; F16M 11/02

(52) U.S. Cl. 248/121; 248/176.1; 248/176.3

(57) ABSTRACT

Device for placing dish-shaped receptacles above one another, comprising a vertical column disposed on a mobile frame, the column carrying a number of vertical rows of support members. Each support member comprises two protrusions situated in one horizontal line and a third protrusion in the middle between the two other protrusions, and at a certain distance below them. The column is formed by a number of profiles that are U-shaped in cross-section, which with the back portions of the U face each other. The two protrusions that are in one line are formed by spaced apart indentations or recesses formed in the legs of each U-profile, for forming the protrusions and the third protrusion is formed by arms, attached to an elongated beam and which arms have been inserted in openings disposed in the back portion of each U-profile.

### CROSS-REFERENCE TO RELATED APPLICATION

The present application is a national stage filing of International patent application Serial No. PCT/NL2008/050346 filed Jun. 3, 2008 and published in English the content of which is hereby incorporated by reference in its entirety.

### BACKGROUND

An aspect of the invention relates to a device serving to place dish-shaped receptacles, such as plates, dishes, serving trays, etc. at a desired mutual distance above one another, which device comprises a vertical column disposed on a mobile frame, the column having a number of vertical rows of support members divided over its circumference, which support members have been disposed at a desired intermediates space above one another, wherein each support member serves to accommodate a receptacle in the desired position, and each support member comprises three protrusions, of which two are situated in one line in horizontal direction and the third protrusion, which is longer than the two other protrusions, is situated approximately in the middle of the two other protrusions, at a certain distance from the line connecting the two other protrusions, which distance is adjustable.

Such a device is known from applicant's European patent 0 432 81 3. When using this known device it is possible to store a large number of plates, each of which is provided with a ready product or semi-finished product, in a cooler or freezer, wherein the device together with the plates take up little space, as the plates provided with a product can be placed above one another without the plates touching the product of another plate. An additional advantage is that also in the unused condition the device takes up very little space and can easily be stored. The edge of a large number of similarly shaped receptacles such as a plate, a dish, serving tray etc. can be placed between the protrusions of a support member, wherein the lower protrusion, which is longer than the two upper protrusions, each time supports the bottom side of the receptacle such as a plate, whereas the edge of the plate supports against the two upper protrusions, as a result of which the plate is held almost horizontally balanced and does not touch the plate placed above or below it. The lowermost protrusions can be adjusted with respect to the upper protrusion as regards height, which makes it possible to adjust the support members to the height of the plates or dishes and to the different shapes and sizes of the receptacles.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

In one embodiment, a device serves to place dish-shaped receptacles, such as plates, dishes, serving trays, etc. at a desired mutual distance above one another, which device comprises a vertical column disposed on a mobile frame, the column having a number of vertical rows of support members divided over its circumference, which support members have been disposed at a desired intermediate space above one another, wherein each support member serves to accommodate a receptacle in the desired position, and each support member comprises three protrusions, of which the first and second protrusion are situated in one line in horizontal direction and the third protrusion, which is longer than the first and second protrusion is situated approximately in the middle of the first and second protrusion, at a certain distance from the line connecting the first and second protrusion. The column is formed with a number of profiles that are U-shaped in cross-section, which each with the back portion of the U are facing each other, so that the legs of the U project radially to the outside, wherein spaced apart indentations or recesses have been formed in the legs of each U-profile that are situated opposite each other, wherein each indentation of the one leg is horizontally in one line with the corresponding indentation of the other leg, for forming the first and second protrusion of each supporting element that are situated in one line, and in that the third protrusions are formed by arms that have been attached at mutual distances to an elongated beam, which arms have been inserted in openings, disposed in the back portion of the U of each U-shaped profile.

In one embodiment synthetic top pieces of a heat resistant synthetic material have been disposed at the edges of the indentations in the legs of the U-shaped profiles.

In one embodiment the openings in the back portion of each U-shaped profile consist of slot-shaped openings, that are spaced apart from each other and situated in each others extension, and the third protrusions have been formed with elongated arms of sheet metal, which at the free end have been provided with a cap of a heat resistant synthetic material, wherein the length of the slot-shaped openings exceeds the height of the arms.

In one embodiment thereof each arm at the end facing away from the cap has a part that is bent at 90° which has a threaded opening, with which said arm can be attached to the beam by means of a screw.

In one embodiment thereof the arm at the end of the bent part has a hooking member extending beyond said bent part, and able to hook through an opening disposed in the beam.

In one embodiment the beam to which the arms have been attached, has a substantially U-shaped profile in cross-section, wherein the ends of the legs of the “U” have been provided with hook-shaped lips, that are able to hook in corresponding openings, which openings are disposed in the back portion of the “U” of the U-profiles forming the column.

In one embodiment an adjustment screw has been provided at the beam, of which screw the threaded portion is connected to the beam and of which the head is connected to the U-profile in question, so that the beam by rotating the adjustment screw can be moved longitudinally with respect to the U-profile in question.

In one embodiment, a device for holding articles includes a vertical column having a U-shaped profile in cross-section and has outwardly projecting first and second legs. Each of the first and second legs includes a plurality of spaced apart indentations, wherein portions of each of the legs between the spaced apart indentations form a corresponding plurality of support members on each leg. Each support member on the first leg is horizontally aligned with a support member on the second leg to define a pair of support members. A portion of the vertical column between the first and second legs includes a plurality of spaced apart openings along a length of the vertical column. A plurality of arms is provided, wherein an arm is disposed in each opening such that the arms of the plurality of arms extend between the legs in a spaced apart manner. Each arm is associated with a different pair of support members and extends outwardly beyond ends of the pair of associated support members. Each pair of support members and associated arm are configured to hold an article.

### SHORT DESCRIPTION OF THE DRAWINGS

Aspects of the invention will be further elucidated on the basis of the drawing, in which,

FIG. 1 shows a view in perspective of a device according to aspects of the invention;

FIG. 2 shows a schematic horizontal cross-section of the column of the device of FIG. 1;

FIG. 3 shows a vertical cross-section of a part of a U-profile of the column;

FIG. 4 shows a view of a part of the U-beam, carrying the third protrusion.

### DETAILED DESCRIPTION OF THE ILLUSTRATIVE EMBODIMENT

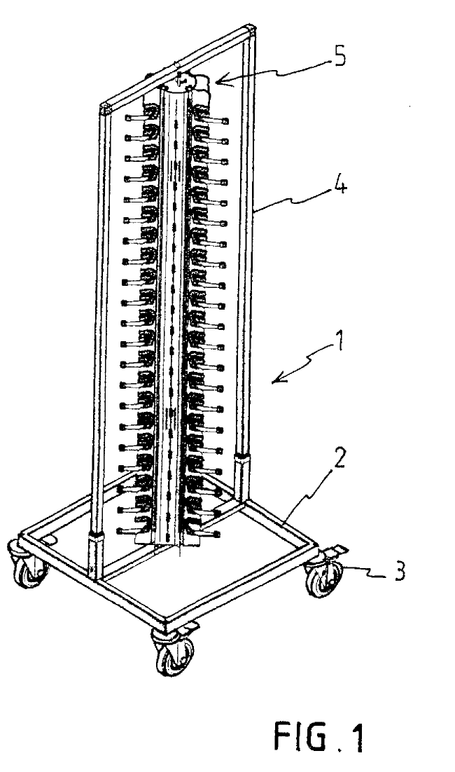

As can clearly be seen in FIG. 1, the device includes a mobile frame 1, comprising a lowermost rectangular framework 2, which at its corners is provided with wheels 3. On the lowermost framework 2 a vertical rectangular framework 4 is disposed, wherein between the horizontal beams of said framework that are situated opposite each other, a column is disposed, which as a whole is indicated by reference number 5. Said column 5 contains a number of vertical rows of supporting elements that are situated at a mutual distance above one another for carrying the plates or dishes, which may each have been provided with a product.

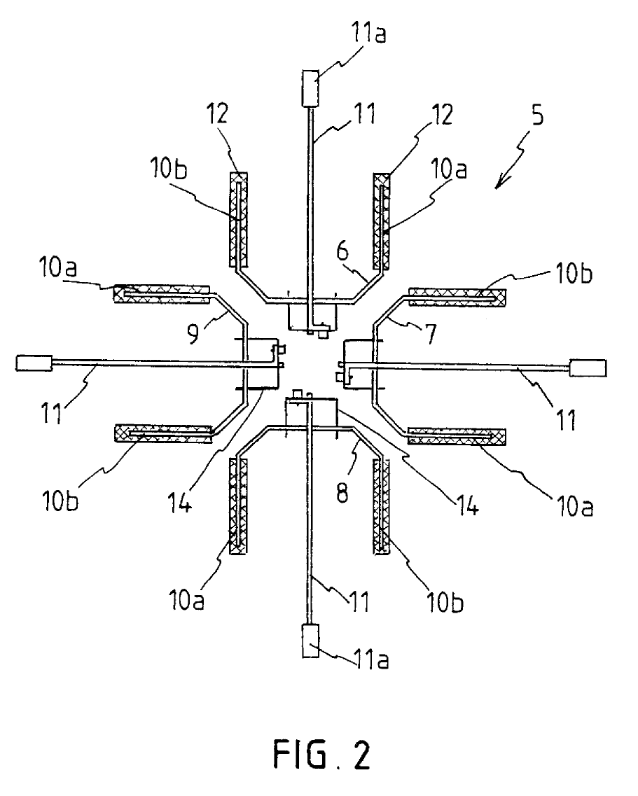

As can be seen in FIG. 2 the column 5 comprises four identical profiles 6,7,8,9 that are U-shaped in cross-section, and which are situated opposite each other in pairs, the backs of the U facing each other. The legs of each U thus extend radially to the outside.

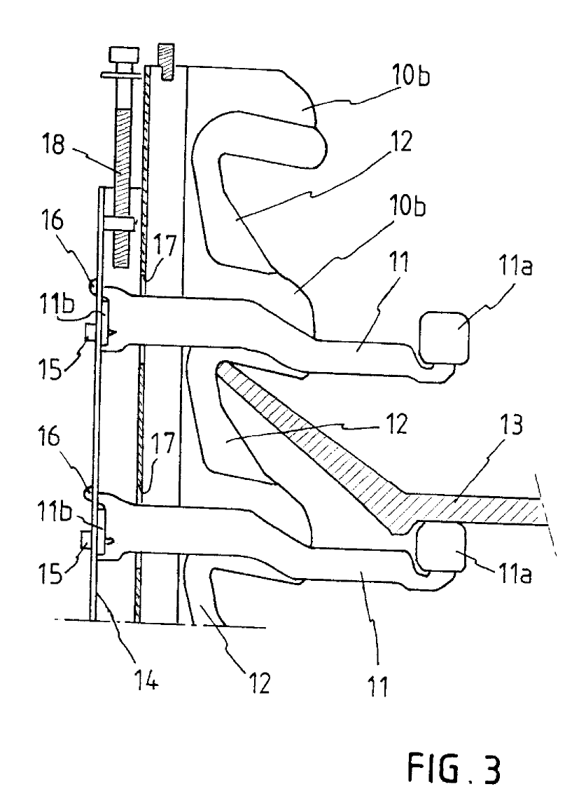

As also shown in FIG. 3, each U-profile has a number of supporting elements that are situated at a mutual distance above one another, wherein each supporting element is formed by two protrusions 10a, 10b in the legs of the U, which in horizontal direction are situated in one line and a third protrusion 11, that is situated in the middle between both protrusions 10a, 10b in the legs of the U, at some distance below the line connecting both protrusions 10a, 10b. The third protrusion 11 clearly is longer than the protrusions 10a, 10b in the legs of the U that are both situated in one line. The protrusions 10a, 10b in the legs of each U-profile are formed by a number of indentations or recesses disposed in the legs at a mutual distance. In each of said indentations an insert piece 12 is disposed, which in any case covers the lowermost edge of the protrusion 10a, 10b (therefore corresponds with the uppermost edge of the indentation) and the edge of the indentation connecting thereto. Said insert pieces 12 are made of a synthetic material, resistant against high temperatures up to approximately 150° C.

FIG. 3 shows a cross-section of a part of a receptacle 13, such as a plate or dish, held in the supporting element 10a, 10b, 11. As can be seen in this figure, the upper edge of the plate abuts the bottom side of the two protrusions 10a and 10b, situated in one horizontal line, of the legs of the U-profile (of which in FIG. 3 only one 10b is visible), whereas the bottom side of the plate rests on the end of the third protrusion 11. Said end of the protrusion 11 has also been provided with a cap 11 of a suitable synthetic material, that is also resistant against temperatures up to approximately 150° C.

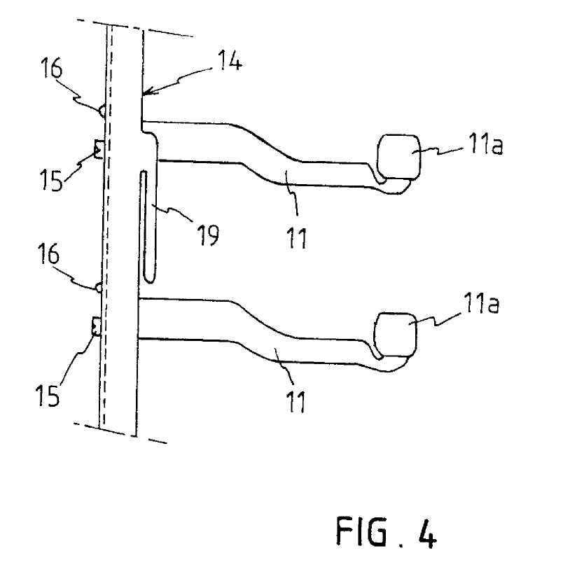

In FIGS. 3 and 4 it can also be seen how the protrusions 11 have been attached to the U-profiles 6,7,8,9. The protrusions are attached spaced apart above one another to the back portion of an in cross-section U-shaped beam 14 (also see FIG. 2), which clearly is smaller than the U-profiles 6,7,8,9. Each protrusion 11 consists of a flat arm 11 made out of sheet metal, which arm at one end has a lip 11b bent at 90°. Said lip 11b has been provided with a threaded hole, so that the arm 11 can be attached to the back portion of the U of the beam 14 by means of a screw 15. In order to ensure that the arm 11 has sufficient bearing power to support the receptacles filled with a product, the arm 11 has a hook-shaped member 16 at the end of the bent lip 11b, which member 16 extends beyond the bent lip 11b. Said hook-shaped member 16, hooks into a corresponding opening, disposed in the back portion of the beam 14.

The back portions of the U-profiles 6,7,8 and 9 have been provided with slot-shaped openings 17 that are in each others extension and disposed such that in each opening an arm may be inserted. The openings are slightly longer than the height of each arm 11, so that there is the possibility that beam 14 with the arms 11 connected thereto, can be moved with respect to the U-profiles 6,7,8 and 9, in longitudinal direction of the said U-profiles. For that purpose an adjustment screw 18 has been provided at the upper side of the beam 14, which screw with the threaded portion is connected to the beam 14 and of which the head is connected to the corresponding U-profile, so that by rotating the adjustment screw the beam 14 slides in the longitudinal direction of the U-profile in question. It will be clear that the connection of the beam 14 to the U-profile in question has to be such so as to make said movement possible. As can be seen in FIG. 4 both legs of the U of the beam 14 have been provided with two hook-shaped lips 19 near the upper side and near the lower side, which lips are situated horizontally in one line. Said lips 19 may hook through the slot-shaped openings disposed in the back portion of the U-profiles, such that the wall of said back portion is partially accommodated in the slot between the lip 19 and the end of the legs of the U of beam 14. By rotating the adjustment screw 18 the beam 14 therefore moves in longitudinal direction over the rear side of the back portion of the U-profile in question, wherein the arms 11 move in the openings 17. In this way the distance of the third protrusion (arm 11) to the horizontal line, connecting the two protrusions 10a and 10b, can be changed to adjust the device to the type of plate or dish 13 to be placed therein.

It will be clear that the device is not limited to the embodiment shown and discussed herein, but that to the expert in this field many changes and varieties are possible that fall within the scope of the attached claims.

What is claimed is:

1. A device for holding dish-shaped receptacles at a desired mutual distance above one another comprising:
a vertical column;
a plurality of support members mounted on the column in a vertical row, which support members are disposed at a desired intermediate space above one another, wherein each support member serves to accommodate a receptacle in a desired position, and each support member comprises three protrusions, of which a first and a second protrusion are situated in one line in a horizontal direction and a third protrusion, which is longer than the first and the second protrusion, is situated approximately in the middle of the first and the second protrusion, at a certain distance from the line connecting the first and second protrusion, wherein the column is formed with a U-shaped profile in cross-section, so that the legs of the U-shaped profiles project outwardly, wherein spaced apart indentations or recesses have been formed in the legs of the U-shaped profile that are situated opposite each other, wherein each indentation of the one leg is horizontally in one line with the corresponding indentation of the other leg, for forming the first and second protrusion of each support member that is situated in one line, and in that the third protrusions are formed by arms that have been attached at mutual distances to an elongated beam, which arms have been inserted in openings, disposed in a back portion of the U of the U-shaped profile.

2. The device according to claim 1, wherein the edges of the indentations in the legs of the U-shaped profile include synthetic top pieces of a heat resistant synthetic material.

3. The device according to claim 1, wherein the openings in the back portion of the U-shaped profile include slot-shaped openings, that are spaced apart from each other and situated in each others extension, and the third protrusions have been formed with elongated arms of sheet metal, which at the free end have been provided with a cap of a heat resistant synthetic material, wherein the length of the slot-shaped openings exceeds the height of the arms.

4. The device according to claim 3, wherein each arm at the end facing away from the cap has a part that is bent at 90° which has a threaded opening, with which said arm can be attached to the beam by a screw.

5. The device according to claim 4, wherein the arm at the end of the bent part has a hooking member extending beyond said bent part, and able to hook through an opening disposed in the beam.

6. The device according to claim 1, wherein the beam to which the arms have been attached, has a substantially U-shaped profile in cross-section, wherein the ends of the legs of the “U” have been provided with hook-shaped lips, that are able to hook in corresponding openings, which openings are disposed in the back portion of the “U” of the U-profile forming the column.

7. The device according to claim 1, wherein an adjustment screw has been provided at the beam, of which screw the threaded portion is connected to the beam and of which the head is connected to the U-profile in question, so that the beam by rotating the adjustment screw can be moved longitudinally with respect to the U-profile.

8. The device according to claim 9, wherein the column comprises four U-profiles, which with their back portions facing each other, are situated opposite each other in pairs.

9. The device according to claim 1, wherein the column has a number of vertical rows of support members divided over its circumference, and the column is formed with a number of profiles that are U-shaped in cross-section, wherein back portions of the U-shaped profiles face each other so that the legs of the U project radially to the outside.

10. The device according to claim 1, and further comprising a mobile frame, the column being mounted to the frame.

11. A device for holding articles comprising:
a vertical column having a U-shaped profile in cross-section and formed of outwardly projecting first and second legs, each of the first and second legs including a plurality of spaced apart indentations, wherein portions of each of the legs between the spaced apart indentations form a corresponding plurality of support members on each leg, wherein each support member on the first leg is horizontally aligned with a support member on the second leg to define a pair of support members, and wherein a portion of the vertical column between the first and second legs includes a plurality of spaced apart openings along a length of the vertical column; and
a plurality of arms, wherein an arm is disposed in each opening such that the arms of the plurality of arms extend between the legs in a spaced apart manner, wherein each arm is associated with a different pair of support members and extends outwardly beyond ends of the pair of associated support members, each pair of support members and associated arm being configured to hold an article.

12. The device according to claim 11, wherein the edges of the indentations in the first and second legs of the U-shaped profile include synthetic top pieces of a heat resistant synthetic material.

13. The device according to claim 11, wherein each arm at end proximate the column has a part that is bent at 90°.

14. The device according to claim 13, wherein each arm at the end of the bent part has a hooking member.

15. The device according to claim 11, and further comprising an elongated beam secured to the U-shaped profile, wherein each of the arms are mounted to the elongated beam.

16. The device according to claim 15, wherein the elongated beam has a substantially U-shaped profile in cross-section, and wherein elongated edges of the beam include hook-shaped lips that are able to hook in corresponding apertures disposed in a back portion of the vertical column.

17. The device according to claim 15, and further comprising an adjuster configured to adjust a longitudinal position of the elongated beam relative to the vertical column.

18. The device according to claim 11, wherein the U-shaped profile and the associated plurality of arms comprise an elongated assembly and wherein the device comprises a plurality of elongated assemblies.

19. The device according to claim 18 wherein back portions of the U-shaped profiles of a pair of elongated assemblies face each other so that the corresponding arms of each of the elongated assemblies extend outwardly away from each other.

20. The device according to claim 11, and further comprising a mobile frame, the column being mounted to the frame.
